(19) United States
(12) Patent Application Publication
(10) Pub. No.: US 2008/0129248 A1
(43) Pub. Date: Jun. 5, 2008

(54) SYSTEM AND METHOD OF POWER MANAGEMENT

(75) Inventors: Tien-Ming Hsu, Taipei (TW); Keng-Hung Yeh, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DELTA ELECTRONICS, INC., Taiwan (TW)

(21) Appl. No.: 11/740,528

(22) Filed: Apr. 26, 2007

(30) Foreign Application Priority Data
Nov. 30, 2006 (TW) 095144541

(51) Int. Cl. H02J 7/00

(52) U.S. Cl. 320/136

(57) ABSTRACT

A power management system for a device is provided. The power management system includes a functional module and a control module electrically connected with the functional module. The control module controls the functional module when a power status signal matches with a power threshold signal.

### FIELD OF THE INVENTION

The present invention relates to a system and a method of power management, and more particular to the system and method of power management for a portable device.

### BACKGROUND OF THE INVENTION

Lots of portable devices, such as the notebook computer, personal digital assistant, multi-functional cell phone, MP3 and etc. have appeared on the markets. In addition to the main functions, these portable devices usually also have minor functions. Taking the multi-functional cell phone as an example, its main function is communication. Nevertheless, besides the communication function, the multi-functional cell phone also has some additional functions, such as playing music, photography, voice-control and etc. These additional functions, however, are usually power consuming.

The prior power monitoring device of the portable device usually shows the remaining electric power on the display or alarms the user via a buzzer while the electric power is relatively low. Therefore, the user needs to check the display so as to understand the current electric power constantly. If the user does not check the electric power constantly and recharge the portable device in time, the user would be alarmed by the buzzer that the electric power of the portable device is really low. Nevertheless, it is to be noted that the buzzer alarm always represents the electric power is at a relatively low status. While the available electric power is almost out, the basic communication function would not work.

The drawback of the mentioned power monitoring mechanism is mainly resulting from that there is no control on the low threshold of the electric power and there is no control on the distributions of the electric power among the various functions.

Please refer to FIG. 1, which is a diagram showing the data processing system capable of reducing the relevant power consumption in Taiwan Patent No. I261164 issued on Sep. 1, 2006. As shown in FIG. 1, the data processing system 10 includes a plurality of functional modules 12, an operation system 17, a power control module 18, a basic input output system 20, a user interface application 30, a plurality of predetermined power profiles 31 and a user interface 32. The user (not shown) could select at least one of a plurality of power profile opinions 34 via the user interface 32. The power control module 18 has a first power control ship 22 and a second power control chip 24. The plurality of functional modules 12 includes a plurality of plug-and-play support modules 14a, 14b and 14c, and non plug-and-play support modules 16a, 16b and 16c. The plurality of predetermined power profiles 31 correspond to a plurality of power control commands 19. After the user selects one from the plurality of power profile options 34, a corresponding power control command 19 would be transferred to the power control module according to the predetermined power profile 31 corresponding to the selected power profile option 34. In addition, a communication signal 21 would be transferred from the basic input output system 20 to the operating system 17 after the user decides to have a communication. The power control module 18 would selectively power on and/or power off the plurality of functional modules 12 based on the predetermined power profile 31 corresponding to the selected power profile option 34.

In briefly, the mentioned data processing system relates to a computer system capable of powering off the unnecessary standby functions. For example, if only the function of playing DVD is activated, the system would actively power off the unnecessary power-consuming functions and/or softwares and/or hardwares, such as PCMCIA card, which would not be used during the playing of DVD. Another example is that when the function of playing music is activated, the system would actively power off the infrared signal transmission module which would not be used during the playing of music but is power-consuming.

The main object of the mentioned prior art relates to power off the standby functional modules so as to save the power, but it fails to perform the well control and management on the power for keeping the basic communication function. That is to say, a cell phone with the mentioned system of Taiwan Patent No. I261164 (issued on Sep. 1, 2006) is capable of saving the electric power by directly powering off the standby function modules. Nevertheless, such cell phone still might meet the situation that all the electric power is used up during the playing of music and the basic communication does not work at that time.

As mentioned above, the new system and method of proper power management able to overcome the drawbacks of the conventional system and method are highly desired.

### SUMMARY OF THE INVENTION

In accordance with an aspect of the present invention, a power management system for a device is provided. The system of power management includes a functional module, and a control module electrically connected with the functional module. The control module controls the functional module when a power status signal matches with a power threshold signal.

Preferably, the power management system further has a basic input output system electrically connected with the control module, a human machine interface electrically connected with the basic input output system and providing the power threshold signal to the control module via the basic input output system, and a power monitoring module providing the power status signal to the control module.

Preferably, the control module provides a first message to the human machine interface and then the human machine interface provides a second message to a user based on the first message.

Preferably, the second message includes an information of an available amount of a power of the device and inquires whether the functional module should be powered off.

Preferably, the functional module is a communication module.

Preferably, the functional module is a voice-control module.

Preferably, the functional module is a photography module.

Preferably, the functional module is a music module.

Preferably, the control module is used for powering off the functional module.

In accordance with another respect of the present application, a method for managing a power of a device is provided. The method includes steps of a) providing a procedure, b) providing a power status signal, c) providing a power threshold signal corresponding to a functional module, d) comparing the power status signal with the power threshold signal to obtain a comparison result, and e) controlling the functional module based on the comparison result.

Preferably, the functional module is powered off in the step e).

Preferably, the method further has steps of: f) providing a human machine interface capable of providing the procedure and the power threshold signal, g) providing a power monitoring module capable of providing the power status signal, and h) providing a control module capable of performing the steps d) and e).

Preferably, the method further includes steps of: i) providing a first message to the human machine interface from the control module, and j) providing a second message to a user from the human machine interface based on the first message.

Preferably, the second message includes an information of an available amount of the power and inquires whether the functional module should be powered off.

Preferably, the functional module is a communication module.

Preferably, the functional module is a voice-control module.

Preferably, the functional module is a photography module.

Preferably, the functional module is a music module.

In accordance with another respect of the present application, a method for managing a power of a device is provided. The method includes steps of: a) setting a predetermined power threshold and a function corresponding to the predetermined power threshold, b) monitoring the power for determining a power status, c) comparing the power status with the power threshold to obtain a comparison result, and d) performing the function based on the comparison result.

Preferably, the function is performed by one selected from a group consisting of a communication module, a voice-control module, a photography module and a music module.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a diagram showing the data processing system capable of reducing the relevant power consumption in the prior art;

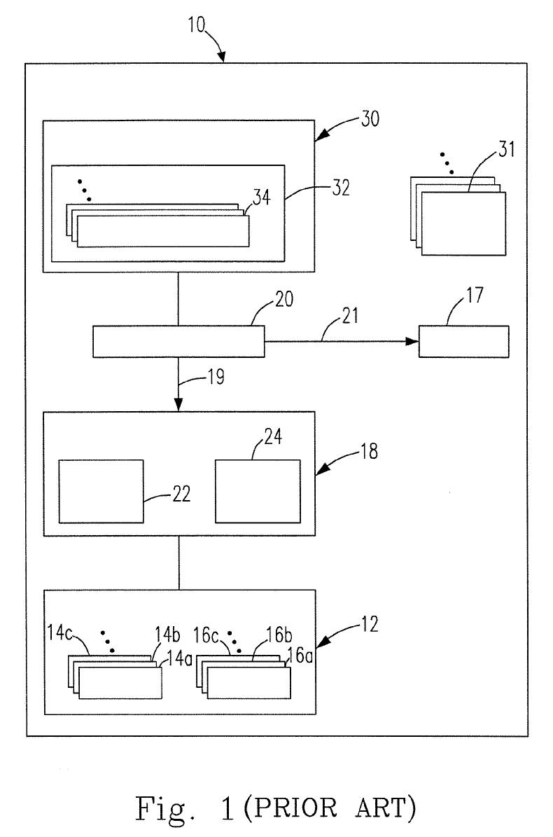

FIG. 2 is a diagram showing the system of power management according to a preferred embodiment of the present application;

FIG. 3 is a setting diagram according to a preferred embodiment of the present application;

FIG. 4 is a diagram showing the procedures of the system of power management according to a preferred embodiment of the present application; and

FIG. 5 is a diagram showing the inquiry for the user according to a preferred embodiment of the present application.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

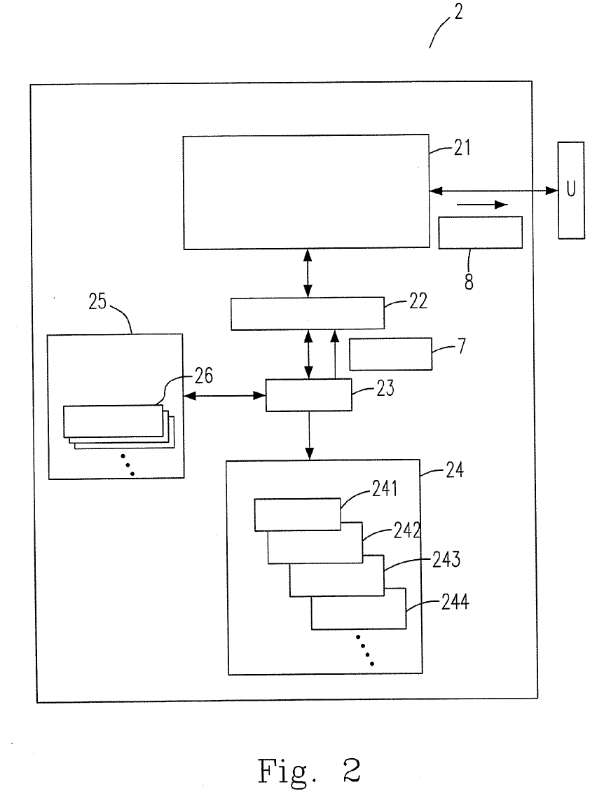

Please refer to FIG. 2, which is a diagram showing the system of power management according to a preferred embodiment of the present application. As shown in FIG. 2, the system of power management 2 includes the human machine interface 21, the basic input output system 22, the control module 23, the functional module 24 and the power status monitoring module 25. Preferably, the system of power management 2 is a power management system of a cell phone. In this embodiment, the functional module 24 includes the communication sub-module 241, the voice-control sub-module 242, the photography sub-module 243, and the music sub-module 244.

The power status monitoring module 25 constantly provides signals representing the various current power status values 26 of the electric power to the control module 23. In addition, when the user U would like to start a function of the functional module 24, the power status monitoring module 25 provides a first signal 7 representing the current power status value 26 to the control module 23. And then, the control module 23 would notice the user U of the current power status value 26 via the second signal 8 and the human machine interface 21.

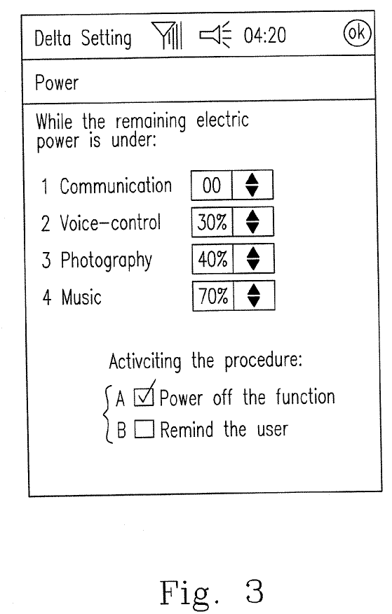

Please refer to FIG. 3, which is a setting diagram according to a preferred embodiment of the present application. Please refer to FIGS. 2 and 3, it is realized that the user could set the respective procedures A and B for the various power status values via the human machine interface 23. Certainly, the respective procedures for the various power status values could be predetermined in the system of power management 2 in this embodiment. In this embodiment, the procedure A represents to power off a function of the functional module 24 and procedure B represents to remind the user with the current electric power status. The procedure A or B might relate to the operation of the control module 23, such as that the control module 23 could power off a function of the functional module 24 based on the set procedure A or B. It is to be noted that there might be plural functional modules in the system of power management of this application. In addition, the procedure A or B might be an inquiry for the user to decide whether a specific function should be powered on or powered off.

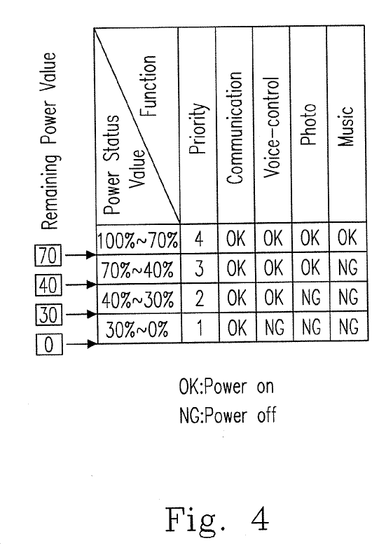

Please refer to FIG. 4, which is a diagram showing the procedures of the system of power management according to a preferred embodiment of the present application. Please refer to FIGS. 2 and 4, the priorities of the different functions in the functional module 24 are arranged as: 1. Communication, 2. Voice-control, 3. Photography and 4. Music. After setting the procedures, the control module 3 could control the power consumption based on the current power status value 26 and the set procedures. For example, when the current power status value 26 from the power status monitoring module 25 is ranged from 70-100%, all the functions in the functional module 24 are active. Nevertheless, while the current power status value 26 from the power status monitoring module 25 is ranged from 40-70%, the function of playing music in the functional module 24 is powered off based on the control module 3 and the set procedures. Similarly, while the current power status value 26 from the power status monitoring module 25 is ranged from 30-40%, the functions of playing music and photography in the functional module 24 are powered off. And, while the current power status value 26 from the power status monitoring module 25 is under 30%, only the function of communication in the functional module 24 is powered on.

In addition, it is also possible to set a procedure to make the control module 23 transmits a first signal representing the current power status value 26 to the human machine interface 21 via the basic input output system 22. And then, the human machine interface 21 provides a second signal to the user for reminder and inquiry based on the first signal from the control module 23.

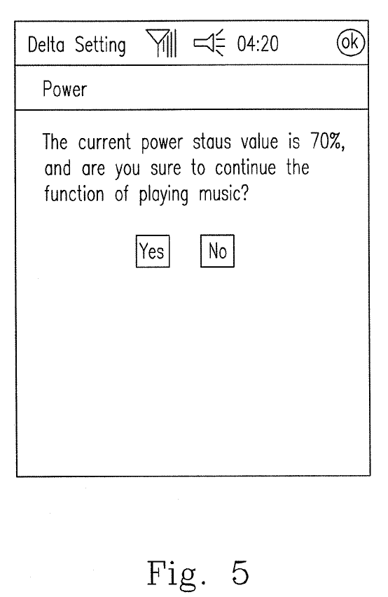

Please refer to FIG. 5, which is a diagram showing the inquiry for the user according to a preferred embodiment of the present application. As shown in FIG. 5, the human machine interface 21 inquires the user whether the function of playing music should be powered off, and then the user could make a decision based on his demand. In addition, the procedures could be set as to automatically power off the unnecessary functions while the current power status value matches with the predetermined power threshold value.

Please refer to FIGS. 2 and 4 again. While the user would like to power on the function of playing music, the control module 23 would receive a power status value 26 from the power monitoring module 25. If the current power status value 26 is 80%, then the function of playing music would be powered on. Nevertheless, if the current power status value 26 is 60%, then the function of playing music would be powered off. Certainly, the relevant procedure could be set as a reminder and inquiry to the user rather than automatically power off the function.

Based on the illustrations in FIG. 4, it is understood that the function of communication has the highest priority in this embodiment. The various functions would be gradually powered off with the reducing power status, and the system of power management in this embodiment could remind and/or inquire the user whether a function of the device should indeed be powered on. Accordingly, the power of the device could be properly managed and it is easy to leave the last power to the communication function. It is possible to reduce the chance that all the power is consumed by the minor standby functions and the major function of communication has no power to work.

As mentioned above, the method and system of power management in the embodiment could properly distribute and control the power and then the higher priority function could be kept workable under the low power status.

While the invention has been described in terms of what is presently considered to be the most practical and preferred embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A power management system for a device, comprising:
a functional module; and
a control module electrically connected with the functional module and controlling the functional module when a power status signal matches with a power threshold signal.

2. A power management system according to claim 1, further comprising:
a basic input output system electrically connected with the control module;
a human machine interface electrically connected with the basic input output system and providing the power threshold signal to the control module via the basic input output system; and
a power monitoring module providing the power status signal to the control module.

3. A power management system according to claim 2, wherein the control module provides a first message to the human machine interface and then the human machine interface provides a second message to a user based on the first message.

4. A power management system according to claim 3, wherein the second message includes an information of an available amount of a power of the device and inquires whether the functional module should be powered off.

5. A power management system according to claim 1, wherein the functional module is a communication module.

6. A power management system according to claim 1, where the functional module is a voice-control module.

7. A power management system according to claim 1, wherein the functional module is a photography module.

8. A power management system according to claim 1, wherein the functional module is a music module.

9. A power management system according to claim 1, wherein the control module is used for powering off the functional module.

10. A method for managing a power of a device, comprising steps of:
a) providing a procedure;
b) providing a power status signal;
c) providing a power threshold signal corresponding to a functional module;
d) comparing the power status signal with the power threshold signal to obtain a comparison result; and
e) controlling the functional module based on the comparison result.

11. A method according to claim 10, wherein the functional module is powered off in the step e).

12. A method according to claim 10, further comprising steps of:
f) providing a human machine interface capable of providing the procedure and the power threshold signal;
g) providing a power monitoring module capable of providing the power status signal; and
h) providing a control module capable of performing the steps d) and e).

13. A method according to claim 10, further comprising steps of:
i) providing a first message to the human machine interface from the control module; and
j) providing a second message to a user from the human machine interface based on the first message.

14. A method according to claim 13, wherein the second message includes an information of an available amount of the power and inquires whether the functional module should be powered off.

15. A method according to claim 10, wherein the functional module is a communication module.

16. A method according to claim 10, where the functional module is a voice-control module.

17. A method according to claim 10, wherein the functional module is a photography module.

18. A method according to claim 10, wherein the functional module is a music module.

19. A method for managing a power of a device, comprising steps of:
a) setting a predetermined power threshold and a function corresponding to the predetermined power threshold;
b) monitoring the power for determining a power status;
c) comparing the power status with the power threshold to obtain a comparison result; and
d) performing the function based on the comparison result.

20. A method according to claim 19, wherein the function is performed by one selected from a group consisting of a communication module, a voice-control module, a photography module and a music module.
